(19) United States
(12) Patent Application Publication
(10) Pub. No.: US 2014/0232336 A1
(43) Pub. Date: Aug. 21, 2014

(54) CHARGING STATION

(71) Applicant: Alexander Kepka, Nuernberg (DE)

(72) Inventor: Alexander Kepka, Nuernberg (DE)

(73) Assignee: SIEMENS AKTIENGESELLSCHAFT, MUENCHEN (DE)

(21) Appl. No.: 14/351,614

(22) PCT Filed: Oct. 12, 2011
(86) PCT No.: PCT/EP2011/067798

§ 371 Date: Apr. 14, 2014

(51) Int. Cl. B60L 11/18

(52) U.S. Cl. CPC B60L 11/1831; B60L 11/182
USPC 320/108

(57) ABSTRACT

A charging station for inductively charging an electric vehicle includes a movable primary coil that can generate a magnetic field in order to charge the electric vehicle. The primary coil is mounted in a movable manner in such a way that the coil can be moved by the electric vehicle and positioned relative to a secondary coil of the electric vehicle when the vehicle drives into the region, vicinity or range of the charging station. An inductively chargeable electric vehicle and a method for operating a charging station are also provided.

The invention relates to a charging station for inductively charging an electric vehicle.

A charging station of said kind has a primary coil which cooperatively interacts with the secondary coil of an electric vehicle for the purpose of charging the latter.

The object underlying the invention is to disclose a charging station with which it is possible to achieve a particularly accurate positioning of the primary coil of the charging station relative to the secondary coil of the electric vehicle that is to be charged.

This object is achieved according to the invention by means of a charging station having the features recited in claim 1. Advantageous embodiments of the charging station according to the invention are disclosed in dependent claims.

According to the invention it is thus provided that the charging station has a movable primary coil which is able to generate a magnetic field for the purpose of charging the electric vehicle, the primary coil being movably mounted in such a way that it can be moved by the electric vehicle and positioned relative to a secondary coil of the electric vehicle when the vehicle drives into range of the charging station.

A significant advantage of the charging station according to the invention is to be seen in the fact that with said charging station a self-initiating or automatic adjustment of the primary coil of the charging station relative to the secondary coil of the electric vehicle can be effected when the electric vehicle drives into range, since the primary coil of the charging station according to the invention is specifically mounted so as to be movable. This enables the electric vehicle, when driving into the range of the charging station, to move or displace the primary coil and thus position or align the same in an optimal manner relative to the secondary coil of the electric vehicle. It is therefore possible within the scope of the movability of the primary coil to adjust the primary coil to the optimal position and thereby bring about an optimal energy transfer from the charging station in the direction of the electric vehicle.

According to a particularly preferred embodiment of the charging station it is provided that the movable primary coil is mounted on a rail in such a way that it can be displaced by the electric vehicle—when the latter drives into range of the primary coil—along the longitudinal direction of the rail (given corresponding orientation of the rail, i.e. for example along the direction of travel). By displacing the primary coil it is possible to make allowance for the fact that when the electric vehicle stops within the range of the charging station it will always have a certain parking tolerance which can be compensated by a displacement of the primary coil along the longitudinal direction of the rail.

In addition or alternatively it can be provided that the movable primary coil is mounted indirectly or directly on a carrier which is swivel able about a pivot and can be swiveled by the electric vehicle when the latter drives into range of the primary coil. Swiveling the carrier of the primary coil enables a lateral tolerance of the position of the electric vehicle within the range of the charging station to be compensated: For example, an optimal adjustment of the primary coil relative to the secondary coil can also be achieved even when the electric vehicle is not driven exactly centrally—referred to the position of the primary coil—into the charging station's range.

According to a particularly preferred embodiment of the charging station it is provided that the swivel able carrier has a rail or is formed by a rail which can be swiveled about a pivot, permits the primary coil to be displaced in the longitudinal direction of the rail and can be swiveled by the electric vehicle when the electric vehicle drives into range of the primary coil. By swiveling and shifting the primary coil it is possible in a very simple manner to achieve an optimal position of the primary coil relative to the secondary coil and consequently an optimal transfer of energy between the two coils.

It is furthermore considered advantageous if the movable primary coil is mounted on the swivel able carrier or the rail in a spring-loaded manner and can be pressed downward by the electric vehicle when the latter drives into range of the primary coil. Differences in height of the electric vehicles which may be due to differences in design or to variations in tire size or tire pressure etc. can be equalized in a very simple manner by means of a spring, thus allowing an optimal vertical positioning of the primary coil relative to the secondary coil.

A spring-loaded mounting of the primary coil can be achieved in a particularly advantageous manner if a telescopic device is arranged between the swivel able carrier or the rail and the primary coil, which telescopic device presses the primary coil upward in a spring-loaded manner and permits the same to be pressed downward by the electric vehicle.

In order to ensure that the primary coil assumes a predetermined starting position at all times in the initial state, i.e. before an electric vehicle drives into range and prior to the commencement of a charging operation, it is considered advantageous if the primary coil is retained in a spring-loaded manner and in the absence of any external application of force adopts a predetermined starting position. Preferably the carrier parts which retain the coil (e.g. carriers, rails, swivel able rails, etc.) are themselves also spring-loaded in such a way that at times when no external force is applied they assume a defined starting position predetermined there for.

The invention furthermore relates to an inductively chargeable electric vehicle which can be charged by means of a charging station as has been described above. According to the invention it is provided in respect of such an electric vehicle that the electric vehicle has a secondary coil and a positioning device which is suitable for positioning a movable primary coil of a charging device relative to the secondary coil of the electric vehicle.

By means of the positioning device inventively provided on the electric vehicle it is possible in a particularly simple manner to achieve an automatic positioning (or alignment) of the primary coil of the charging station relative to the secondary coil when the electric vehicle drives into range of the charging station and consequently a particularly low-loss charging of the electric vehicle. The advantages of the charging station according to the invention therefore apply in an analogous manner to the electric vehicle according to the invention.

According to a particularly preferred embodiment of the electric vehicle it is provided that the positioning device is arranged on the floor pan of the vehicle and comprises two side walls spaced apart from each other (preferably oriented downward) which converge rearwardly toward each other and toward the secondary coil in the vehicle's longitudinal direction. The primary coil can be intercepted and aligned in a particularly simple manner by means of two side walls converging in a rearward direction toward each other (e.g. in a funnel-shaped or funnel-like manner); while the electric vehicle advances into range the side walls will namely deflect the primary coil sideways and move it into the optimal position underneath the secondary coil of the electric vehicle.

In a particularly preferred embodiment of the electric vehicle it is provided that the positioning device is formed by means of an intercept pod, the side walls of which form the side walls of the positioning device, wherein the secondary coil is arranged at the rear end of the intercept pod viewed in the vehicle's longitudinal direction. A positioning device in the form of an intercept pod can be manufactured in a particularly simple manner, for example even in a single piece, such that an optimal positioning of the pod side walls relative to each other and relative to the secondary coil arranged at the end of the intercept pod is realized automatically already at the time of pod manufacture.

The invention furthermore relates to an arrangement comprising a charging station, as has been described above, and an electric vehicle, as has been described above.

The invention furthermore relates to a method for operating a charging station for the purpose of charging an electric vehicle. According to the invention it is provided in respect of such a method that when the electric vehicle drives into range of the charging station a movable primary coil of the charging station is aligned relative to the secondary coil of the electric vehicle by a positioning device arranged on the floor pan of the electric vehicle.

With regard to the advantages of the method according to the invention, reference may be made to the statements set forth above in connection with the charging station according to the invention, since the advantages of the inventive charging station substantially correspond to those of the inventive method.

It is considered advantageous if a primary coil which is slid able along a rail is displaced along the direction of travel by means of a positioning device arranged on the floor pan of the electric vehicle when the electric vehicle drives into range of the charging station.

In addition or alternatively it can be provided that the primary coil connected to a telescopic or spring-loaded device is pressed downward in the direction of the floor by means of a positioning device arranged on the floor pan of the vehicle.

Alternatively or in addition it can be provided that the positioning device arranged on the floor pan of the vehicle swivels a rail carrying the primary coil about a pivot in order to achieve an optimal positioning of the primary coil relative to the secondary coil.

The invention is explained in more detail below with reference to exemplary embodiments, where by way of example:

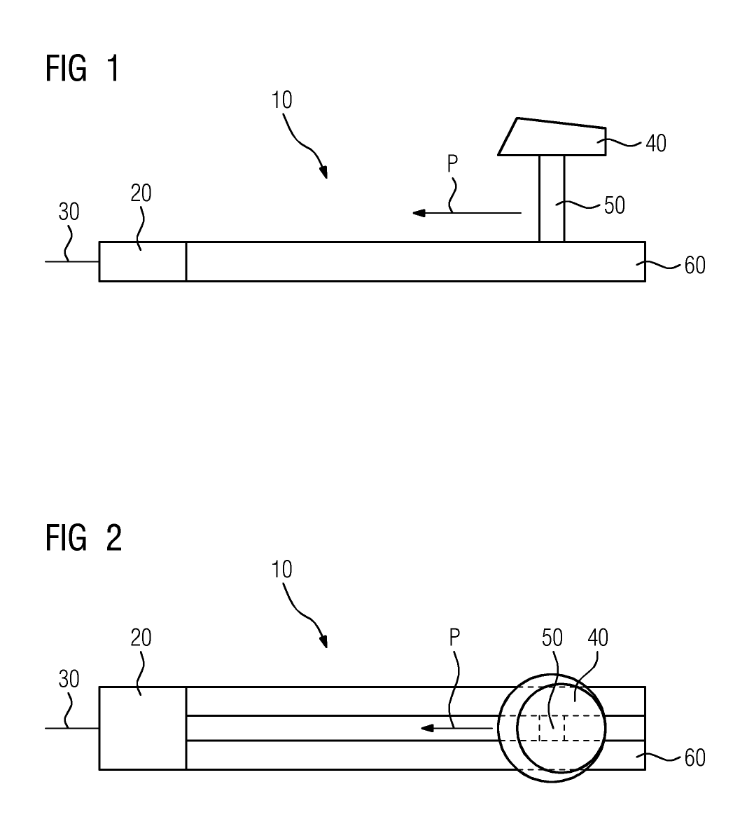

FIG. 1 shows a first exemplary embodiment of a charging station according to the invention in a view from the side,

FIG. 2 shows the charging station according to FIG. 1 in a view from above,

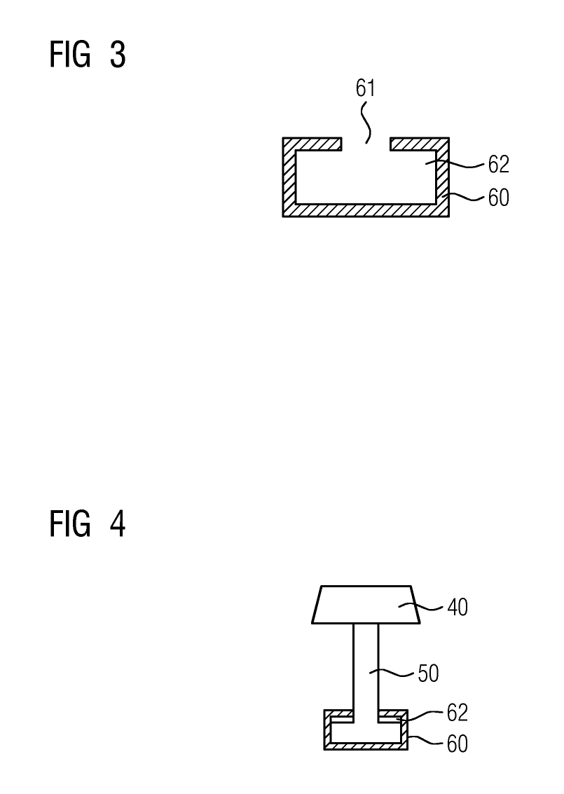

FIG. 3 shows an exemplary embodiment of a rail of the charging station according to FIGS. 1 and 2 in cross-section,

FIG. 4 shows the rail according to FIG. 3 after a carrier element carrying a primary coil of the charging station has been inserted into the rail,

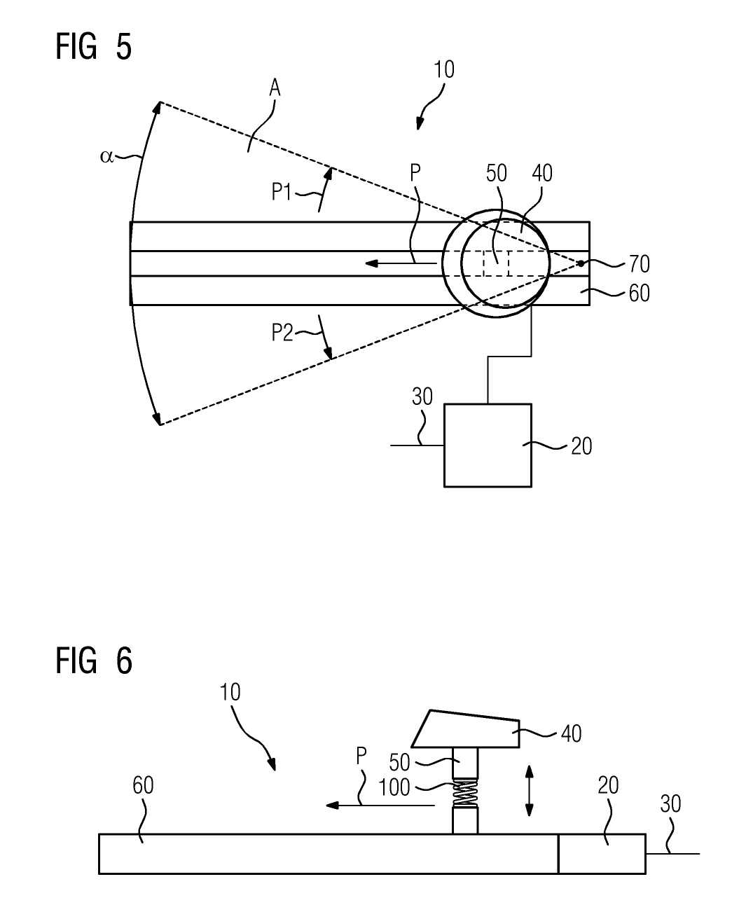

FIG. 5 shows a second exemplary embodiment of a charging station according to the invention, in which the coil is slidably mounted on a swivel-mounted rail,

FIG. 6 shows a third exemplary embodiment of a charging station according to the invention in which the coil is mounted so as to be movable slidably along the longitudinal direction of a rail as well as in a spring-loaded manner in the vertical direction,

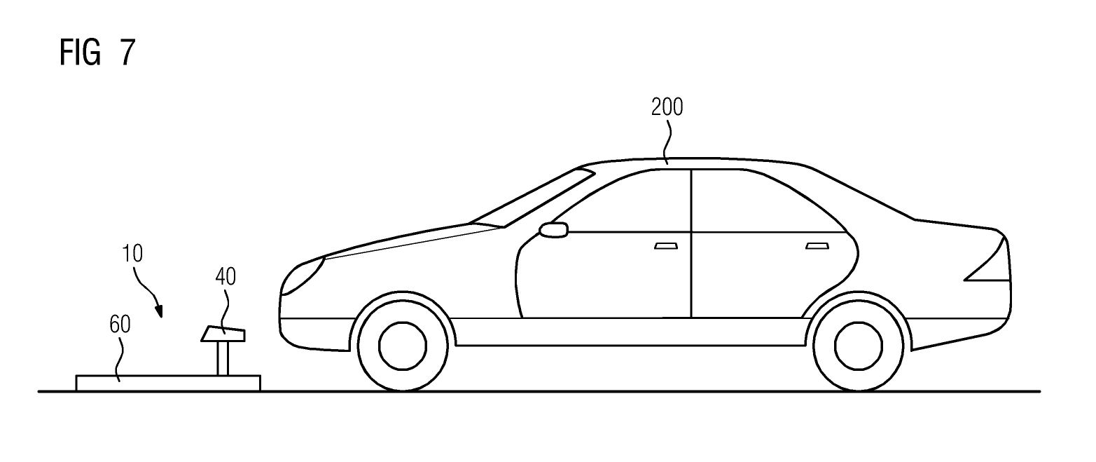

FIG. 7 shows an exemplary electric vehicle which drives into range of a charging station according to FIG. 5,

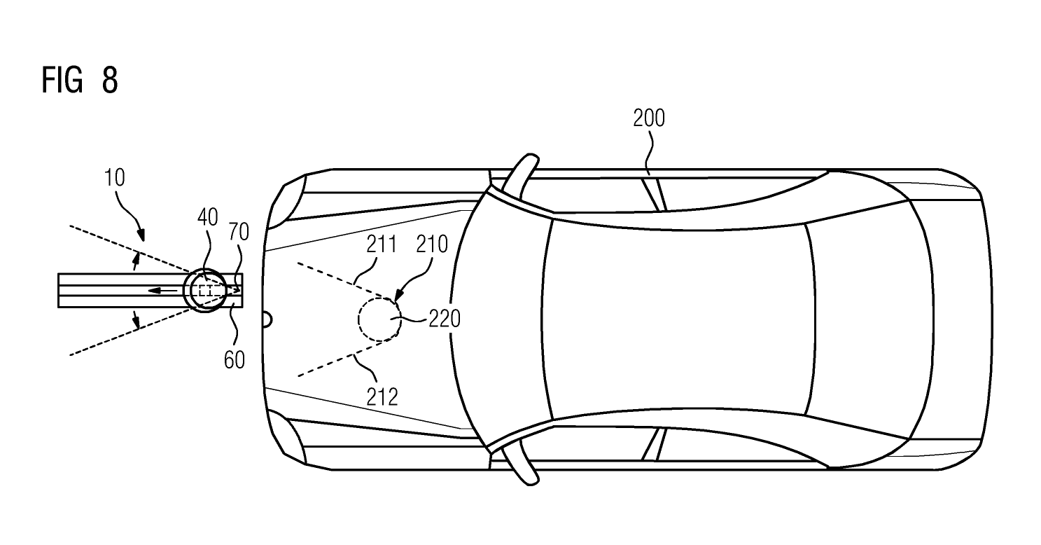

FIG. 8 shows the electric vehicle according to FIG. 7 in a view from above,

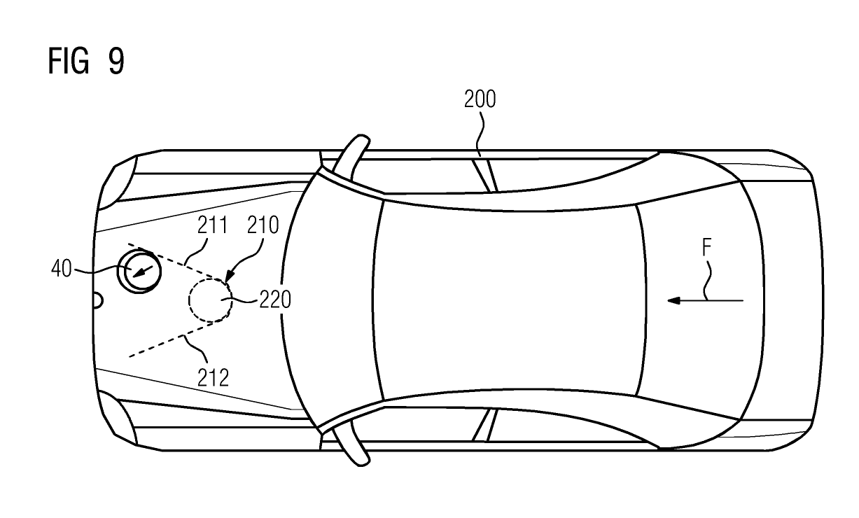

FIG. 9 shows the electric vehicle according to FIGS. 7 and 8 after it has assumed a position above the charging station,

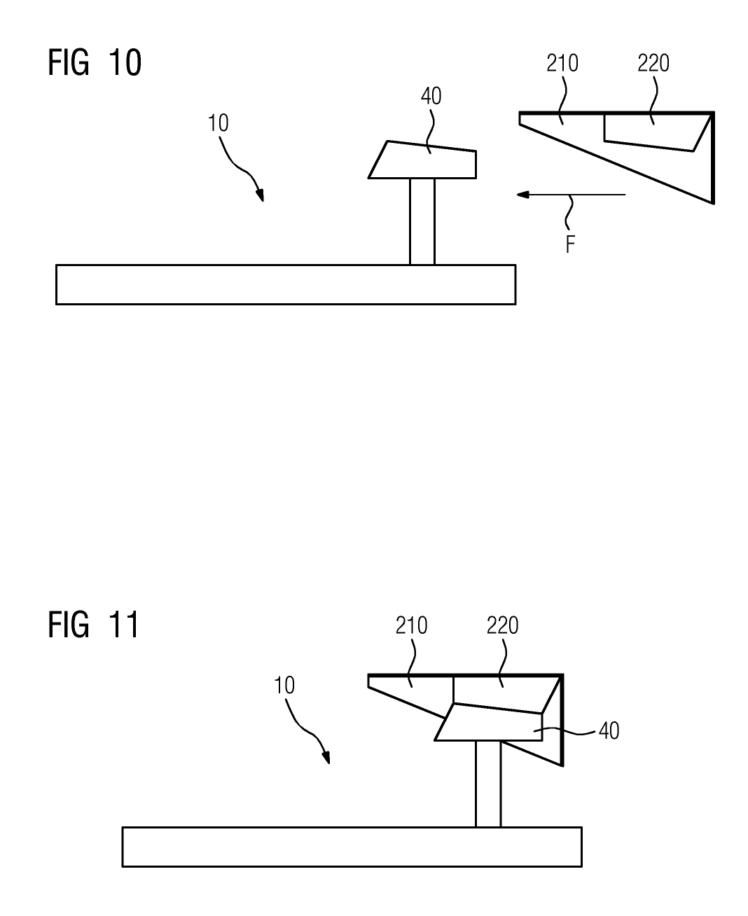

FIG. 10 shows the adjustment of the primary coil of the charging station above the secondary coil of the electric vehicle in a view from the side, and

FIG. 11 shows the primary coil of the charging station aligned underneath the secondary coil of the electric vehicle.

For clarity of illustration reasons the same reference signs are used in all cases in the figures for identical or comparable components.

Referring to FIG. 1, a charging station 10 can be seen which is equipped with a control device 20. The control device 20 is connected via a connection 30 to an energy distribution network that is not shown in further detail. The function of the control device 20 consists in controlling, monitoring and if necessary protecting the charging operation for inductively charging an electric vehicle that is not shown in FIG. 1.

As can be seen in FIG. 1, the charging station 10 has a primary coil 40 which is connected to the control device 20 via electrical leads (not shown in further detail) and is fed via the latter with energy which is transferred inductively to the electric vehicle by way of the primary coil 40.

The primary coil 40 is mounted on a carrier element 50 which is slid ably guided in a rail 60. By attaching the primary coil 40 to the slid able carrier element 50 it is possible to displace the primary coil 40 along the direction of the arrow P for the purpose of its adjustment relative to the secondary coil of an electric vehicle.

FIG. 2 shows the charging station 10 according to FIG. 1 in a view from above. The primary coil 40 can be seen along with the carrier element 50 which is slidably guided in the rail 60. In the case of the exemplary embodiment according to FIG. 2 it is therefore possible to displace the primary coil 40 along the direction of the arrow P in the direction of the control device 20.

The arrangement of the control device 20 in the exemplary embodiment according to FIGS. 1 and 2 is to be understood only by way of example. The control device 20 can be arranged at the left-hand end of the rail 60 as shown in FIG. 2 or else at the right-hand end of the rail 60 or else completely detached from the rail 60.

FIG. 3 shows the rail 60 of the charging station 10 according to FIGS. 1 and 2 in greater detail by way of example. It can be seen that the rail 60 has a top opening slot 61 through which the carrier element 50 can engage into the interior 62 of the rail 60.

In the exemplary embodiment according to FIG. 3, the interior 62 of the rail 60 is approximately rectangular in cross-section; this is to be understood only by way of example, however. Alternatively the interior 62 can also be a different shape in cross-section, for example square, round, oval or polygonal.

FIG. 4 shows the rail 60 according to FIG. 3 after the carrier element 50 has been inserted into the interior 62. It is accordingly possible to displace the carrier element 50 together with the primary coil 40 located thereon along the longitudinal direction of the rail 60; in the illustration according to FIG. 4 the longitudinal direction of the rail 60 extends orthogonally with respect to the image plane, in other words into the image plane or, as the case may be, out of the image plane.

FIG. 5 shows a second exemplary embodiment of a charging station 10. In this exemplary embodiment the primary coil 40 is likewise slid ably mounted on a rail 60. Toward that end the primary coil 40 is mounted—as also in the case of the exemplary embodiment according to FIGS. 1 to 4—on a carrier element 50 which is slid ably guided in the rail 60.

It is additionally provided in the case of the exemplary embodiment according to FIG. 5 that the rail 60 is swivel-mounted. Toward that end a pivot 70 is provided which retains the rail 60 and allows the rail 60 to swivel along the arrows P1 and P2.

When an electric vehicle drives into range of the charging station 10 it is accordingly possible to displace the primary coil 40 not only translation ally along the direction of the arrow P, but in addition also perpendicularly to the direction of the arrow P. It is therefore possible in the case of the exemplary embodiment according to FIG. 5 to position the primary coil 40 inside the circular segment A, the size of which is defined by the maximum swiveling angle α of the rail 60.

In order to avoid the control device 20 being moved as well together with the rail 60 when the latter is swiveled, said control device 20 is preferably mounted in a stationary manner at a fixed location next to the rail 60, as is shown by way of example in FIG. 5.

FIG. 6 shows an exemplary embodiment of a charging station 10 in which the primary coil 40 is mounted by way of a slid able carrier element 50 on a swivel ably retained rail 60, as has been explained in connection with the exemplary embodiment according to FIG. 5.

In order in addition to achieve an adjustment of the primary coil 40 in the vertical direction also, the charging station 10 according to FIG. 6 additionally has a spring-loaded or telescopic device 100 which retains the coil 40 in a spring-loaded manner relative to the rail 60. It is accordingly possible to press the primary coil 40 vertically downward if this is necessary in order to effect a coupling with a secondary coil of an electric vehicle.

The spring-loaded or telescopic device 100 is preferably embodied in such a way that it exerts a pretensioning effect on the primary coil 40 in such a way that the latter assumes a predetermined height above the rail 60 without any major application of force.

FIG. 7 shows by way of example the positioning of the primary coil 40 of the charging station 10 according to FIG. 5 when an electric vehicle 200 drives into range of the charging station 10. In this case FIG. 7 depicts the situation before the electric vehicle drives into range in a view from the side.

FIG. 8 shows the electric vehicle 200 and the charging station 10 according to FIG. 7 in a view from above. It can be seen that the primary coil 40 of the charging station 10 is mounted on the rail 60 in a slid able manner, the rail 60 being able to swivel about the pivot 70.

Also apparent in FIG. 8 is a positioning device 210 which comprises two side walls 211 and 212 which are spaced apart from each other and—viewed in the direction of travel of the electric vehicle—converge toward the rear. A secondary coil 220 of the electric vehicle 200 is located in the rearward end of the positioning device 210; energy can be coupled into said secondary coil 220 from the primary coil 40 of the charging station 10 in order to charge the electric vehicle with electrical energy.

The positioning device 210 can be formed for example by means of a one-piece intercept pod (made for example from plastic, e.g. fiber-reinforced plastic), the side walls of which form the side walls 211 and 212 of the positioning device.

FIG. 9 shows the electric vehicle according to FIGS. 7 and 8 after it has been driven over the primary coil 40 of the charging station 10. It can be seen that the primary coil 40 is intercepted by the upper (in FIG. 9) side wall 211 of the positioning device 210 and is pressed downward (in FIG. 9)—or to the left, viewed in the direction of travel F—by the latter. If the electric vehicle 200 advances further along the direction of travel F, then the primary coil 40 will be pressed in the direction of the secondary coil 220 due to the action exerted by the upper (in FIG. 9) side wall 211, such that an optimal alignment is achieved between the primary coil 40 of the charging station 10 and the secondary coil 220 of the electric vehicle 200.

In the drive-in situation shown in FIG. 9, only the side wall 211 of the positioning device 210 cooperates in the positioning or alignment of the primary coil 40. Alternatively, in a different drive-in situation, the lower (in FIG. 9) side wall 212 of the positioning device 210 can provide for an optimal positioning of the primary coil 40.

The electric vehicle 200 is shown driving into range of the charging station 10 once again in a side view in a schematic representation in FIGS. 10 and 11. FIG. 10 shows the electric vehicle's positioning device 210, embodied as a one-piece intercept pod, with the secondary coil 220 contained therein which is moved toward the charging station 10 in the direction of travel F of the electric vehicle.

FIG. 11 illustrates the situation after the primary coil 40 of the charging station 10 has been brought into an optimal position relative to the secondary coil 220 owing to the action exerted by the positioning device 210. It can be seen that the primary coil 40 is located directly beneath the secondary coil 220, such that an optimal inductive energy transfer from the primary coil 40 to the secondary coil 220 is possible.

Although the invention has been illustrated and described in greater detail on the basis of the preferred exemplary embodiments, it is not limited by the disclosed examples and other variations may be derived here from by the person skilled in the art without leaving the scope of protection of the invention.

1-10. (canceled)

11. A charging station for inductively charging an electric vehicle, the charging station comprising:
a movable primary coil configured to generate a magnetic field for charging the electric vehicle;
said primary coil being movably mounted and configured to be moved by the electric vehicle and positioned relative to a secondary coil of the electric vehicle when the electric vehicle drives into a range of the charging station.

12. The charging station according to claim 11, which further comprises a rail having a longitudinal direction, said movable primary coil being mounted on said rail and configured to be displaced by the electric vehicle along said longitudinal direction.

13. The charging station according to claim 11, which further comprises a carrier configured to swivel about a pivot, said movable primary coil being mounted indirectly or directly on said carrier and configured to be swiveled by the electric vehicle when the electric vehicle drives into a range of said primary coil.

14. The charging station according to claim 13, wherein said carrier has a rail or said carrier is a rail configured to be swiveled about said pivot and to permit said primary coil to be displaced in said longitudinal direction and to be swiveled by the electric vehicle when the electric vehicle drives into said range of said primary coil.

15. The charging station according to claim 14, wherein said movable primary coil is mounted and spring-loaded on said swivel carrier or said rail and is configured to be pressed downward by the electric vehicle when the electric vehicle drives into said range of said primary coil.

16. The charging station according to claim 15, which further comprises a telescopic device disposed between said swivel carrier or said rail and said primary coil, said telescopic device configured to press said primary coil upward with spring-loading and to permit said primary coil to be pressed downward by the electric vehicle.

17. The charging station according to claim 11, wherein said primary coil is retained, spring-loaded and adopts a predetermined starting position upon an absence of any external application of force.

18. An inductively chargeable electric vehicle, comprising:
a secondary coil; and
a positioning device configured to position a movable primary coil of a charging station according to claim 11 relative to said secondary coil of the electric vehicle.

19. The electric vehicle according to claim 18, which further comprises:
a vehicle floor and a longitudinal vehicle direction;
said positioning device disposed on said vehicle floor; and
said positioning device including two side walls being spaced apart from each other and converging rearwardly toward each other and toward said secondary coil in said longitudinal vehicle direction.

20. A method for operating a charging station for charging an electric vehicle, the method comprising the following steps:
providing the charging station with a movable primary coil;
providing the electric vehicle with a secondary coil and a vehicle floor; and
positioning the movable primary coil relative to the secondary coil by using a positioning device disposed on the vehicle floor, when the electric vehicle drives into a range of the charging station.
